(19) United States
(12) Patent Application Publication
(10) Pub. No.: US 2008/0162103 A1
(43) Pub. Date: Jul. 3, 2008

(54) METHOD, SYSTEM, AND COMPUTER PROGRAM PRODUCT FOR CONCURRENT MODEL AIDED ELECTRONIC DESIGN AUTOMATION

(75) Inventors: David White, San Jose, CA (US); Louis K. Scheffer, Campbell, CA (US)

Correspondence Address: BINGHAM MCCUTCHEN LLP, THREE EMBARCADERO CENTER, SAN FRANCISCO, CA, 94111-4067, US

(73) Assignee: CADENCE DESIGN SYSTEMS, INC., San Jose, CA (US)

(21) Appl. No.: 11/866,378

(22) Filed: Oct. 2, 2007

Related U.S. Application Data
(60) Provisional application No. 60/877,870, filed on Dec. 29, 2006.

(51) Int. Cl. G06F 17/50

(52) U.S. Cl. 703/13

(57) ABSTRACT

Disclosed are improved methods, systems, and computer program products for predicting performance, manufacturability, and reliability (PMR) using concurrent model analyses for electronic designs. Various embodiments of the present invention disclose a method for predicting PMR with concurrent process model analysis in which a method with concurrent model(s) generate a design for the one or more layers in the electronic circuit. The method then analyzes the impact of the processes or techniques for feature geometric characteristic predictions or PMR evaluations, based upon the concurrent models. Results may be reported to the users, or the method may modify the designs to accommodate the variations and determines one or more parameters based upon the concurrent models. One embodiment determines the impact of concurrent model on one or more of performance, manufacturability, and reliability criteria.

### CROSS-REFERENCE TO RELATED APPLICATION(S)

This application claims the benefit of U.S. Provisional Application No. 60/877,870, filed on Dec. 29, 2006, which is hereby incorporated by reference in its entirety.

### BACKGROUND OF THE INVENTION

As the electronic design feature size continues to shrink into deep submicron regime and the clock frequency increases, the electric properties of wires become more prominent, and chips are more susceptive to breakdown during fabrication due to, for example, antenna effect or to wear out over time due to, for example, electro-migration. Some prior methods propose prioritizing the nets and forcing shorter wire lengths among the high-priority, timing critical nets. However, making certain wires shorter usually comes at the expense of making other wires longer. Some other prior methods use larger gates with bigger transistors and higher drive strengths to charge the capacitance of wires more quickly and therefore making the path faster to maintain timing correctness without overly shortening some wires while lengthening others. However, one problem exists for these methods. In electronic designs, the actual wire lengths are not known until some gates are physically in place. Nonetheless, because larger gates also have larger capacitance and thus increases timing delay, the above solution does not satisfactorily solve the problems caused by increasingly shrinking feature sizes.

Another problem with using larger gates is that larger gates with larger drive strength tend to worsen the problem of electro-migration. Deposited aluminum and copper interconnect have a polycrystalline structure from most fabrication processes; that is, these aluminum and copper interconnects are made of small grain lattices. Metal atoms can be transported between the grain boundaries. Electro-migration occurs during the momentum exchange between the mobile carriers and the atomic lattice as the current flow through the interconnect. As a result of the momentum exchange, metal tends to deposit in the direction of the electron flow, and voids thus form at the grain boundaries and reduce the conductivity. Such voids may over time cause the interconnect to stop conducting electricity altogether and thus cause the interconnect to fail.

Moreover, the continual effort to scale down to the deep submicron region requires multilevel interconnection architecture to minimize the timing delay due to parasitic resistance and capacitance. As the devices shrink smaller, the delay caused by the increased R-C time constant becomes more significant over the delay caused by the actual wire length. In order to reduce the R-C time constant, interconnect materials with lower resistivity and interlayer films with lower capacitance are required. However, the use of low-k dielectric material aggravates the electro-migration problem due to the poor thermal conductivity of these low-k dielectric materials.

One way of resolving the aforementioned problems introduced by the continual reduction in feature sizes is to impose certain density rules for metal filling. Such rules typically comprise certain maximum and minimum densities within certain windows on the chip. Some other rules impose different density limits among different window areas. However, such rules typically assume that the thickness of the wire is constant according to certain formulae and therefore manipulate only the width of the wires to achieve the design goals. Although this assumption arose out of a practical consideration and has worked while the thickness variation is relatively insignificant as compared to the geometry sizes, such an assumption appears to be outdated, especially in light of the current development in incorporating the topological variations of each film into the electronic designs and the continuously shrinkage in sizes of device features. Moreover, wire width cannot be arbitrarily changed due to the polycrystalline structure of the interconnect materials. As a result, additional methods have been developed to slot certain wires such that the metal density within certain region falls within the prescribed maximum and minimum limits.

Nonetheless, the above rule-based methods pose new problems. For instance, a good interconnect may be wrongfully determined to be improper for failing to meet the density rules or for producing unacceptable R-C delay even though the interconnect actually satisfies the design goals by having certain thickness that is different from the assumed value. A contrary example is that a bad interconnect may also be wrongfully determined to be proper for meeting the metal density rules and/or the delay requirement. As a result, there exists a need for a more accurate and effective method for supplanting the above rule-based design criteria and replacing these methods with a new and improved method which takes into account the topographical variation of the films and a new set of rules incorporating thicknesses of the films.

Two timing closure approaches have been adopted, and both keep the gate delay constant under load by sizing the gates. The flaw in these two approaches, as interconnects get longer, is that wire resistance can no longer be neglected. Moreover, keeping the delay constant by sizing the gate offers reasonably accurate approximations only when there is no or insignificantly low resistance between the driving gate and the capacitive load. This is no longer true as the geometry continually shrinks, especially into the deep submicron technologies. Other timing-driven placement methods may also be ineffective because they rely on the quality of the placement and the accuracy of the timing model.

With the advance of deep submicron technologies, resolution enhancement techniques (RET) have become one of the most important techniques to guarantee design for manufacturability (DFM). Nonetheless, RET without taking the surface topology into consideration may pose further challenges to the timing closure due to the continual pursuit for smaller geometry size and the use of shorter wavelength on the lithographic tools such as the 193 nm λ ultra-high NA lithography or even the Extreme Ultra Violet lithography, especially in the deep submicron and increasing clock frequency designs. For example, in order to meet the increasing demand for higher resolution and finer geometries, the semiconductor industry has been pushing in order to obtain larger numerical aperture (NA) to achieve smaller minimum feature size. However, larger NA also decreases the depth of focus, and such decreased depth of focus causes the lithographic tools' ability to print accurate circuits to be more sensitive to the topographical variation of the films on the wafer.

Semiconductor Fabs usually impose certain “design rules”. These rules are picked somewhat arbitrarily such as the requirement that the line width variation be no more than certain nano-meters. For example, the rules may be chosen to ensure that a line drawn as 65 nm wide is constructed at least 55 nm wide, and no more than 75 nm wide. Likewise, the semiconductor foundries may also impose certain metal density limits, usually in the form of percentages, to ensure the design after CMP will have metal thicknesses within certain limits. Continuing from the example above, these percentage limits may be defined to ensure the metal thicknesses are at least 100 nm and no more than 150 nm. These foundry-imposed rules, however, do not take into account the types, functionality, performance specifications of the design; they are indeed manufacturing requirements primarily to ensure that the fabrication yield exceeds some economical number, and to allow the foundry to specify reasonably tight limits on electrical properties such as R and C per unit length. However, in many cases these rules are un-necessarily strict. In some cases, all the designers care about is whether the design is manufacturable, reliable, and/or meets other certain specifications. For example, the designer does not really care how much a non-performance critical design deviates from drawn widths or desired thicknesses, so long as the design meets the reliability and manufacturability specifications. Another example is that some designs may perfectly serve its intended purpose no matter how thin the interconnects are so long as the fundamental manufacturability and reliability requirements are met. As another example, a rule intended to ensure 10 year reliability under continuous operation may be entirely irrelevant to the manufacturer of talking greeting cards.

Design closure is a process by which an integrated circuit (IC) design is modified from its initial description to meet a list of design constraints and design objectives. A constraint is a design target that must be met in order for the design to function as designed. For example, an IC may be required to operate at or above a clock frequency or within a band of frequencies. Such a clock frequency requirement may be considered a constraint. On the other hand, an objective is a design goal which, even if not met, would not cause the IC product to fail or to improperly function. Rather, an design objective is one that more or higher is better. For example, a yield requirement may be considered a design objective as failure to meet the yield requirement would not cause the IC to fail or to function improperly, and the higher the yield the better the profitability will be.

In a typical IC manufacturing process flow, IC manufacturers usually require a minimal yield in order to meet the target cost requirement to manufacture such ICs. Or the IC manufacturers may impose a staggered structure for the cost to manufacture the ICs where the staggered cost structure sets forth the yield requirements and their respective costs for manufacturing. From this ultimate yield requirement, the IC manufacturers may thus generate a list of individual or correlated requirements or rules for the IC designers to meet. In addition, the IC packaging companies may also require certain rules such as the total wattage or power consumption of the IC to be manufactured is not to exceed some predetermined amount. Such rules may arise out of practical concerns. For example, during the die attachment process, the die is normally glued onto the package or is eutectic bonded to the package. Excessive power consumption of the IC inherently dissipates more heat which would cause the bonding or glue layer to deteriorate or ultimately fail.

The design closure problem used to be a much simpler task where an integrated circuit normally consisted of only thousands of logic circuits operating at fairly low frequencies usually in the MHz range. Design closure problems in integrated circuits of this scale do not usually pose much difficulty as the designers may, at some subsequent stage of the design, simply loop back to some earlier stages of the design to address certain violations of the constraints or to better achieve certain design objectives since there are relatively fewer components to consider. For example, if the designer finds that there are too many timing constraints violations left after routing, the designer may simply go back to modify the design or modify some settings of the design tools to re-route the entire design without causing much delay in the entire design process.

Due to the continual effort to shrink the feature sizes and to package more features into a smaller die, the design closure problem has become much more complex. Also, modern integrated circuits commonly operate at much higher frequencies, normally in the gigahertz range, which makes the integrated circuits more susceptible to noises such as cross-talk noise. Moreover, smaller feature sizes normally cause negative effects on the electrical properties of various components in the integrated circuits and thus may adversely impact other aspects of the integrated circuit design. In the previous example where there are too many timing constraint violations after routing, it may no longer economically feasible for the designer to go back and re-route the entire design because doing so would not only cause great delay in the entire design process and thus adversely impacts the time to market but may also incur substantial costs due to the large amount of computation required for such circuits. This problem is further exacerbated due to the dilemma that typically the earlier a design constraint is addressed during a design flow, the more flexibility there will be to properly address the constraint, but the earlier one is in a design flow, the more difficult it is to predict the circuit's compliance with such constraints.

### SUMMARY OF THE INVENTION

Thus, a need exists for a more effective and accurate methodology for determining whether a design meets the designer's intent, design goals, design constraints, or other requirement and whether the design may be manufactured as designed without meeting other requirements, especially in the deep submicron and increasing clock frequency designs. The present invention is directed to an improved method, system, and computer program product for performing such analyses for electronic circuit designs. According to some embodiments of the present invention, the user may use concurrent models for the fabrication, metrology, or image processing processes or techniques to accurately predict the probability distribution of the performance of the electronic design. The user may also combine the output of concurrent models into a discrete value for a given feature or multiple values for a given feature in the form of a distribution. Some embodiments of the present invention utilize the above method, system, or computer program to produce more effective and accurate design closure for electronic circuit designs by evaluating the performance, manufacturability, or reliability (PMR) of the electronic circuit. The method or system of various embodiments of the present invention takes into consideration the geometric characteristics of one or more features of the electronic circuit to be manufactured or the impact of variation of surface topology of an underlying level to more accurately and effectively estimate various metrics of the electronic circuit and thus more precisely predict or evaluate various objectives of the electronic circuit.

### DESCRIPTION OF FIGURES

The drawings illustrate the design and utility of preferred embodiments of the present invention. It should be noted that the figures are not drawn to scale and that elements of similar structures or functions are represented by like reference numerals throughout the figures. In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a general flow of a methodology for performing design closure on multi-level electronic circuits with the aid of a concurrent model.

FIGS. 2A-2B illustrate a methodology for performing design closure on multi-level electronic circuits with the aid of a concurrent model.

FIG. 3 illustrates some embodiments of predicting feature geometric characteristics or variations for a method or system for electronic design automation with the aid of a concurrent model.

FIG. 4 illustrates some exemplary processes or techniques upon which a concurrent model may be constructed.

FIG. 5 illustrates an example of an impact on the DOF of a lithographic process due to topological variations of a film on a substrate introduced by the planarization or deposition processes.

FIG. 6 illustrates an example of an impact on the planarization process due to variations in the electronic circuit design features.

FIG. 7 illustrates the effect of the resputtering and etching processes on the profile of a semiconductor design feature.

FIG. 8 depicts a computerized system on which a method for timing closure with concurrent process models can be implemented.

### DETAILED DESCRIPTION

The present invention is directed to an improved method, system, and computer program product for designing an electronic circuit with concurrent models for fabrication, metrology, or image processing processes or techniques (e.g., RET). Some embodiments of the present invention utilize the above method, system, and/or computer program to produce more effective and accurate design closure for electronic circuit designs by evaluating the performance, manufacturability, or reliability (PMR) of the electronic circuit. The method or system of various embodiments of the present invention takes into consideration the geometric characteristics of one or more features of the electronic circuit to be manufactured or the impact of variation of surface topology of an underlying level and to more accurately and effectively estimate various metrics of the electronic circuit and thus more precisely predict or evaluate various objectives of the electronic circuit.

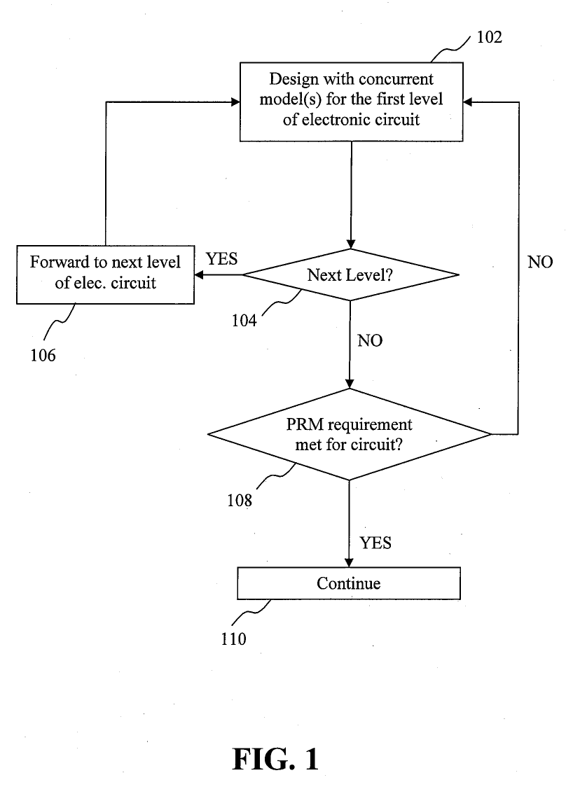

FIG. 1 depicts a high level flow chart of a method for electronic circuit design with concurrent process model analysis. At 102, a circuit designer utilizes a design tool with concurrent fabrication, metrology, or image processing models to generate a design for the first interconnect level. The concurrent models may comprise concurrent models for fabrication processes or techniques, concurrent models for metrology processes or techniques, or concurrent models for image processing processes or techniques. The concurrent fabrication models comprise, for example but shall not be limited to, models for deposition processes, models for removal processes, models for patterning processes, or models for property modification processes or techniques.

In some embodiments of the present invention, a concurrent model may be constructed based purely upon principles of physics and mathematical methods for the process or technique which the concurrent model precisely describes.

In other embodiments, a concurrent model may first be built upon some physics principles and/or mathematical algorithms to approximate the process or technique the concurrent is to describe. Such an approximate concurrent model may be fine tuned with data or information obtained from sources such as a patterned test wafer or from other less accurate but easier or less expensive models with limited fidelity such as a simple analytic model, empirical formulae or models, formulae or models with interpolation or extrapolation of information or data, or other approximations. That is, a concurrent model may be constructed by some, for example, simplified physics principles and/or mathematical methods and may then be fine tuned by data or information obtained from patterned test wafers or from other less accurate but easier or less expensive models with limited fidelity such as a simple analytic model, empirical formulae or models, formulae or models with interpolation or extrapolation of information or data, or other approximations.

In some other embodiments, a concurrent model may be constructed purely upon data or information obtained from one or more patterned test wafers or from other less accurate but easier or less expensive models with limited fidelity such as an empirical formula or models or a formula or model with interpolation or extrapolation of information. For part or all of a given level of an electronic circuit design or even the entire electronic circuit design, there may exist concurrent models built by some or all the aforementioned methods. There may exist concurrent models constructed by more than one of the aforementioned method even for the same process or technique which the concurrent models are constructed to describe. For example, where greater accuracy is desired or where the performance is critical in a sub-circuit, the concurrent model may be built upon physics principles and/or mathematical methods with or without the aid of obtained data or information from patterned test wafers or from other less accurate but easier or less expensive models with limited fidelity such as an empirical formula or models or a formula or model with interpolation or extrapolation of information. As another example, where the performance is not critical in certain part of the electronic circuit or where reducing cost is of greater concern for certain part of a level of the electronic circuit design or certain part of the electronic circuit itself, a concurrent model may be built purely upon information or data obtained from a patterned test wafer or from other sources of limited fidelity such as a simple analytic model, empirical formulae or models, formulae or models with interpolation or extrapolation of information or data, or other approximations. Is shall also be noted that a level of an electronic circuit design corresponds to a level of electronic circuit which may comprise, for example but shall not be limited to, an interconnect level, a metal layer, or a mask level of the electronic circuit.

Moreover, the deposition processes or techniques upon which the one or more concurrent models are built may comprise, for example but shall not be limited to, physical vapor deposition (PVD), chemical vapor deposition (CVD), atomic layer deposition (ALD), electrochemical deposition or electro-plating (ECD), electroless plating or deposition, auto-catalytic plating or deposition, and molecular beam epitaxy (MBE). The removal processes may comprise, for example but shall not be limited to, isotropic or anisotropic wet or dry etching, chemical mechanical polishing (CMP), or reflow processes.

The patterning processes may comprise, for example but shall not be limited to, lithography processes or techniques such as lithography processes or techniques comprise microlithography, nanolithography, photolithography, electron beam lithography, maskless lithography, nanoimprint lithography, interference lithography, x-ray lithography, extreme ultraviolet lithography, or scanning probe lithography, or the plasma ashing processes.

The property modification processes or techniques may comprise, for example but shall not be limited to, ion implantation, annealing, oxidation, UVP (ultraviolet light processing).

The image processing techniques or processes may comprise, for example but shall not be limited to, various resolution enhancement techniques such as ruled-based or model-based Optical Proximity Correction (OPC), Subresolution Assist Features (SRAF), Phase Shifting-Mask (PSM), or Off-Axis Illumination (OAI).

As mentioned above, in some embodiments, the concurrent models for the aforementioned processes or techniques may be constructed by purely referring to the underlying principles of physics with mathematical algorithms. For example, the concurrent models for deposition or removal processes may be constructed by modeling the plasma physics, rarefied gas flow theories, fluid dynamics, diffusion theory, electromagnetism, mechanics, and/or the interactions thereof. The image processing techniques may be constructed by modeling optical physics, electromagnetic wave theories, and/or quantum mechanics. The concurrent models for the metrology processes or techniques may directly model the measurement result by modeling, for example, the thermionical behavior, the field emission effect, or the quantum tunneling effect of the SEM process to simulate the measurement results.

In some other embodiments, the concurrent models for the aforementioned processes or techniques may be constructed by employing some simplified physics models in terms of mathematical methods and then fine tuned or calibrated by the information or data obtained from one or more patterned test wafers with similar or identical features as those to be manufactured in the actual electronic circuit design or from other sources of limited fidelity such as a simple analytic model, empirical formulae or models, formulae or models with interpolation or extrapolation of information or data, or other approximations. For example, the concurrent models may be constructed by adopting certain empirical formulae for certain processes or techniques which may approximate the physical phenomena of the aforementioned processes or techniques within certain tolerable accuracy. Such concurrent models may then be calibrated or fine tuned with the information or data obtained from one or more patterned test wafers with similar or identical features as those to be manufactured in the actual electronic circuit design or from other sources of limited fidelity such as a simple analytic model, empirical formulae or models, formulae or models with interpolation or extrapolation of information or data, or other approximations.

In some other embodiments, the concurrent models for the aforementioned processes or techniques may be constructed by creating certain rules based upon the information or data obtained from one or more patterned test wafers with similar or identical features as those to be manufactured in the actual electronic circuit design or from other sources of limited fidelity such as a simple analytic model, empirical formulae or models, formulae or models with interpolation or extrapolation of information or data, or other approximations. For example, the concurrent models may simply contain certain rules which are built upon the information or data obtained from one or more patterned test wafers or from other sources of limited fidelity such as a simple analytic model, empirical formulae or models, formulae or models with interpolation or extrapolation of information or data, or other approximations. Such rules may comprise, for example but shall not be limited to, metal density rules, spacing rules, rules on geometric characteristics of electronic design features, etc. These rules may be constructed by extracting, interpolating, or extrapolating information or data from one or more patterned test wafers containing similar or identical features as those to be manufactured on the actual electronic circuit or from other sources of limited fidelity. Some embodiments may combine the output of concurrent models into a discrete value for a given feature or multiple values for a given feature in the form of a distribution or a statistical representation of the data such as mean, variance and range.

In some other embodiments of the invention, the method or the system, prior to proceeding to the next act to determine whether there is an additional level for analysis and design, may optionally determine whether a performance, manufacturability, or reliability requirement is satisfied for the first level of the electronic circuit design. Where the method or the system determines that some or all of the performance, manufacturability, or reliability requirements are not satisfied and may not be relaxed, the method or the system of some embodiments of the invention reverts back to 102. In some other embodiments, the method or the system may modify the electronic circuit design for the first level or may modify the processes upon which the concurrent models are determined. Where the method or the system determines that, although some or all of the performance, manufacturability, or reliability requirements are not satisfied, these unmet requirements may actually be relaxed or belong to some don't-care space, the method or the system of some embodiments of the invention may then ignores these violations and proceeds to 104. Where the method or the system determines that some or all of the performance, manufacturability, or reliability requirements are not satisfied, and these requirements may neither be relaxed nor belong to some don't care space, the method or the system of some embodiments of the invention may still proceed to 104 and ignore the violations at the first level momentarily. In some embodiments of the present invention, the method or the system may optionally present an option to the user or the designer and awaits the user or the designer to determine which option the method or the system should choose to proceed in light of the violations of certain performance, manufacturability, or reliability requirements. In certain electronic circuit designs, it may be desirable to invoke this optional determination at an individual level to eliminate certain violations so as to prevent them from propagating to the next level.

Referring back to FIG. 1. At 104, after the circuit designer completes the design, the method or the system determines whether there exists an additional interconnect level or an additional level in the electronic design to analyze. It shall be noted that a level or a layer may refer to an interconnect level, a metal layer, or a mask level in the electronic circuit design or manufacturing. If the method or the system determines there are additional interconnect levels or layers of the electronic circuit design to analyze, the method or the system of various embodiments of the invention then forwards the data or information of the current level of the electronic circuit design to the next level for further analyses and design at 106.

If the method or the system of various embodiments of the invention determines there is no additional level or layer to analyze, the method or the system of various embodiments of the invention forwards the design data and information to perform design closure at 108. If all the design objectives are fulfilled and the design closure model converges, the method proceeds to 110 where the designer may determine to generate the Graphical Data System II (GDS II) file for tapeout or may perform further verification or analysis before final tapeout. However, if the design closure model does not converge the design process goes back to 102 and repeats the above acts until design closure is properly concluded. In some embodiments of the present invention, the objectives of design closure may comprise, for example but shall not be limited to, performance metrics, manufacturability, reliability, or yield of the electronic circuit to be manufactured according to the electronic circuit design under consideration.

More particularly, the method or the system may, based upon the one or more concurrent models, determine whether the electronic design meets one or more of the performance metrics. The performance metrics may be represented in the form of objectives where the more or the better these performance metrics are achieved the better the electronic design is. Such performance metrics may comprise, for example but shall not be limited to, yield or maximum clock frequency. The performance metrics may also be represented in the form of constraints where the electronic design will be considered outside the design specification if the electronic design fails to meet such performance metrics. Such performance metrics may comprise, for example but shall not be limited to, timing requirements or threshold power consumption requirement.

Various embodiments of the invention also more accurately predict or estimate the manufacturability of the electronic circuit to be manufactured by employing the methods or systems described herein. For example, various embodiments of the invention may determine whether an electronic design feature, although violating some foundry imposed design rules and being determined to be not manufacturable as a result, still performs its intended function as designed and shall thus be considered manufacturable. For example, a dielectric may be considered to be outside the permissible range of thickness and is thus non-manufacturable under traditional approaches. Such a dielectric may nonetheless be considered manufacturable in various embodiments of the invention if the one or more concurrent models incorporated in the method or the system actually determines that the dielectric strength of the same dielectric feature actually performs adequately after taking the fabrication, image processing, or the metrology processes or techniques into consideration. That is, the method or the system in some embodiments of the invention would keep this dielectric feature and thus avoid being overly pessimistic while the traditional approaches would simply outlaw such a dielectric for violating some overly simplified rules. Similarly, the method or the system in some embodiments will also avoid being overly optimistic by more accurately determining the characteristics of an electronic circuit design. Take the same dielectric as an example. The conventional approaches may determine that the dielectric is fit for manufacturing if it meets all the simplified rules. The method or the system of some embodiments may nonetheless determine that the dielectric actually may not perform as it is originally designed due to some factors such as the impact from a lower level of electronic circuit design features. In this case, the method or the system of some embodiments of the invention may outlaw the dielectric even though such a dielectric feature may meet all the rules in conventional approaches.

The method or the system of some embodiments of the invention may also better determine or predict the yield of the electronic circuit by employing the one or more concurrent models. The one or more concurrent models in some embodiments of the invention will more accurately determine the geometric characteristics of some electronic circuit design features and thus may more accurately determine the metrics of the electronic circuit design to determine whether some features are manufacturable and some other features should be outlawed. That is, the method or the system of some embodiments of the invention may more accurately predict or estimate the yield of the electronic circuit to be manufactured. Many different approaches in modeling yield are know n to one skilled in the art and thus will not be described in greater details.

Moreover, as the method or the system of various embodiments of the invention more accurately predicts the geometric characteristics, the method or the system of some embodiments of the invention may better predict or estimate the reliability of the electronic component. Take the aforementioned dielectric feature as an example, once the one or more concurrent models determine the geometric characteristics of the electric feature, the one or more concurrent models may then more precisely determine the effects of various physical, thermal, or electrical phenomena on such a dielectric feature. For example, the method or the system of some embodiments of the invention may, based upon the geometric characteristics of the dielectric feature, determine the amount of leakage current under the more realistic operating conditions. Moreover, the method or the system of some embodiments of the invention may, based upon the geometric characteristics of the dielectric feature, predict or estimate the possible potential difference corresponding to the dielectric strength of the dielectric feature. That is, the method or the system of some embodiments of the invention may better predict or estimate the reliability of the electronic circuit to be manufactured.

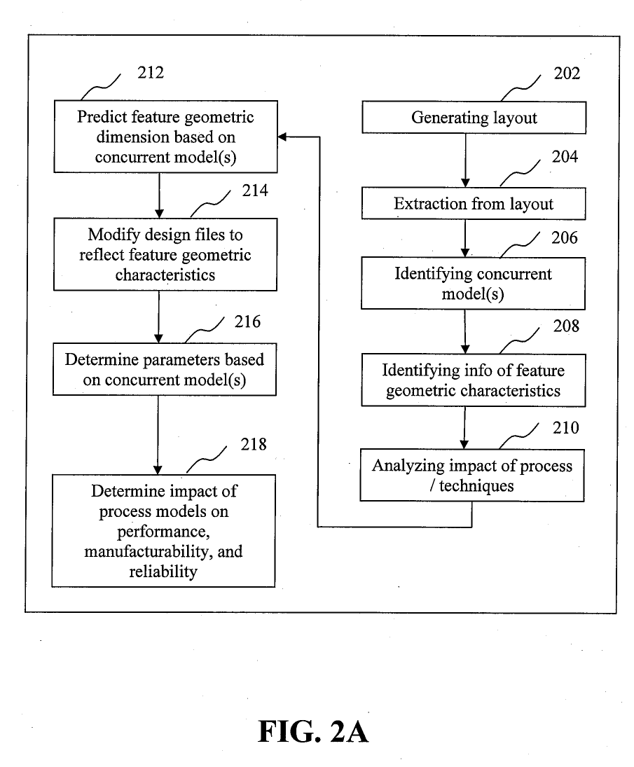

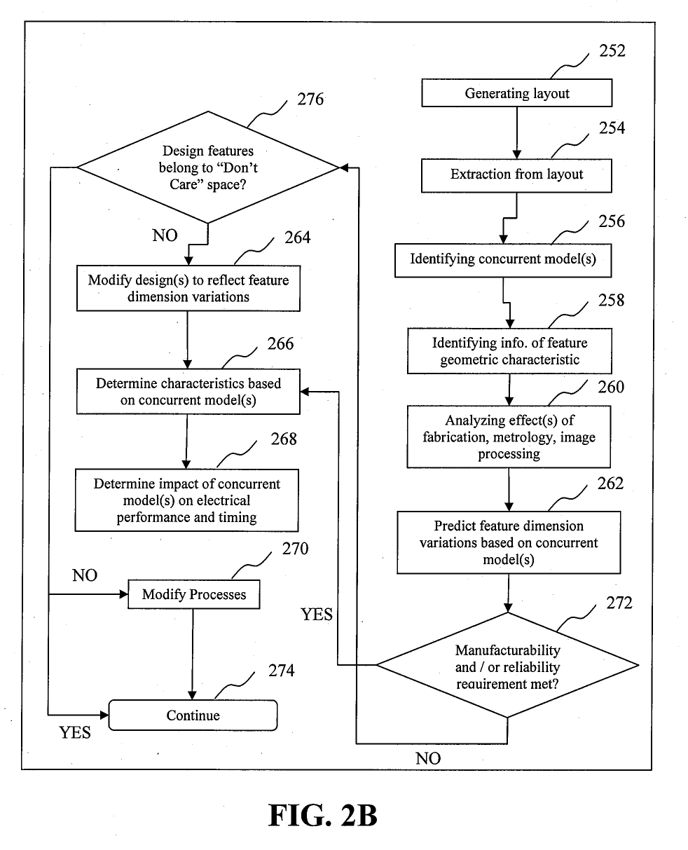

FIG. 2A further illustrates one embodiment of various methods or systems for performing analysis of an electronic circuit design with concurrent models for fabrication, metrology, or image processing processes or techniques.

At 202, the method or the system of various embodiments of the invention generates an electronic circuit design based upon, for example but shall not be limited to, the designer's intent or specification. At 204, the method or the system of various embodiments of the invention performs geometric extraction of the electronic circuit design. The method or the system of various embodiments of the invention then identifies one or more concurrent models for fabrication, metrology, or image processing processes or techniques at 206. The method or the system of some embodiments of the present invention further identifies the information of geometric characteristics of electronic design features such as but shall not be limited to topographical variations of a film on the wafer due to different processes or design features at 208. At 210, the method or the system of some embodiments of the present invention then analyzes the effects or impacts on the electronic circuit of the fabrication, metrology, or image processing processes or techniques upon which the concurrent models are built. At 212, method or the system of some embodiments of the present invention predicts the geometric characteristics or variations of the geometric characteristics of the design features based on the one or more concurrent fabrication, metrology, or image processing models.

Based upon the predicted variations or departures from the feature dimensions and/or characteristics as designed, the method or the system of some embodiments of the present invention then modifies the design file such as a GDS II or OASIS file to reflect the variations of the design feature dimensions and/or characteristics at 214. Such design feature characteristics may comprise, for example but shall not be limited to, geometrical profiles of the electronic circuit design features. At 216, the method or the system of some embodiments of the present invention further determines the electrical, physical, chemical, or thermal parameters based upon the one or more concurrent models.

Such electrical parameters may include, but not limited to, electrical resistance, bulk resistivity, capacitance, R-C time constant, inductance, propagation delay, current densities, or IR drop. Such physical parameters or characteristics may comprise, but not limited to, feature dimensions, feature profiles, uniformity of similar identical or feature characteristics within the same die, uniformity of similar identical or characteristics across the wafer, or uniformity of identical or similar feature characteristics from one wafer to another wafer. Such chemical parameters or characteristics may comprise, but not limited to, chemical composition of a feature of the electronic circuit, bulk density of a species in a feature of the electronic circuit, or distribution of a species within a feature of the electronic circuit. Such thermal parameters may comprise, for example but not limited to, thermal conductivity or thermal expansion coefficient due to different composition of matters in the electronic design features.

The method or the system of some embodiments of the present invention may also determine other parameters due to the introduction of the image processing processes or techniques such as resolution enhancement techniques (RET). Such parameters may comprise, for example but shall not be limited to, amplitude, phase, direction of propagation, and polarization of the light, numerical aperture (NA). The method or the system of various embodiments of the invention then determines the impact of the process models and/or RETs on the electrical performance by performing, for example, electrical power consumption analysis and timing by performing such as static timing analysis (STA) or statistical static timing analysis (SSTA).

Referring back to FIG. 2A. At 218, the method or the system of some embodiments of the present invention may determine the impact of the fabrication, metrology, or image processing processes or techniques upon which the one or more concurrent models are built on the performance, manufacturability, and reliability of the electronic circuit. The method or the system of some embodiments of the present invention may also use a parasitic extraction method to translate the geometric variation into, for example, the corresponding resistance and capacitance values necessary to determine the electrical impact of variation on timing or power of the electronic circuit. The resistance and capacitance values may be in the form of lumped or averaged values for a given net or section of interconnect or subnet, or a distribution of values based on the geometric variations produced by the concurrent models.

FIG. 2B illustrates another embodiment of the method with one or more concurrent models for fabrication, metrology, or image processing processes or techniques.

Similar to the method as illustrated in FIG. 2A, at 252, the method or the system of some embodiments of the present invention in FIG. 2B generates a circuit design layout based upon the designer's intent and specification. At 254, the method or the system of some embodiments of the present invention performs extraction of the design layout. The method or the system of some embodiments of the present invention then identifies one or more concurrent models for fabrication, metrology, or image processing processes or techniques at 256. The method or the system of some embodiments of the present invention further identifies the information about geometric characteristics of features in the electronic design such as topographical variations of the film on the wafer due to different processes and/or design features at 258. At 260, the method or the system of some embodiments of the present invention then analyzes the effects and/or impacts of the fabrication, metrology, or image processing processes or techniques. At 262, the method or the system of some embodiments of the present invention may optionally predict the geometric characteristics of one or more features in the electronic design such as variations of some design feature dimensions and characteristics based on the concurrent models.

Unlike the method or the system of various embodiments of the invention as shown in FIG. 2A, some embodiments of the present invention as depicted in FIG. 2B comprise the act of determining whether certain features meet the design closure requirement, including manufacturability, timing, or reliability requirement(s) at 272. If these features under consideration meet the design closure requirement(s) the method or the system of some embodiments of the present invention proceeds to 266 where the method or the system further determines the characteristics or metrics of the design features based on the concurrent models. If these features do not meet the design closure requirement(s) the method or the system of some embodiments of the invention further determines whether the design features belong to certain “don't care” space at 276 in which features are determined to be unrelated to performance.

If the method or the system of some embodiments of the invention determines that these design features belong to some “don't care space” the method or the system of some embodiments of the present invention terminates properly at 274. If, however, the method or the system of some embodiments of the present invention determines that these design features do not belong to some “don't care space,” that is these features are related to performance of the circuit, the method or the system of some embodiments of the present invention proceeds to 264 to modify the design(s) to reflect the variations in electronic design feature geometric characteristics or to 270 to modify the fabrication, metrology, or image processing process or technique to accommodate the variations in electronic design feature geometric characteristics. An illustrative application of this embodiment is, for example, when certain features of the design, part of the design, or the design itself is not performance critical. In such scenarios, the only criteria for this type of devices are, for example, whether the device or the features are manufacturable and/or whether the device or the features are reliable.

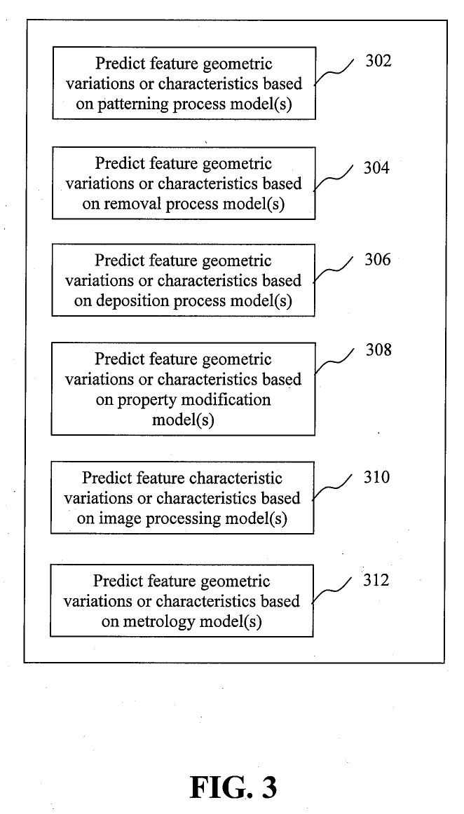

FIG. 3 illustrates an embodiment of the predicting module of some embodiments of the method or system for performing design closure with one or more concurrent models for fabrication, metrology, and/or image processing processes or techniques. The predicting module may include, but not limited to, a sub-module to predict feature dimension variations or characteristics due to patterning process models, 302, due to removal process models, 304, due to deposition process models, 306, due to property modification models, 308, due to one or more models for image processing techniques or processes such as RETs, 310, or due to one or more metrology models 312.

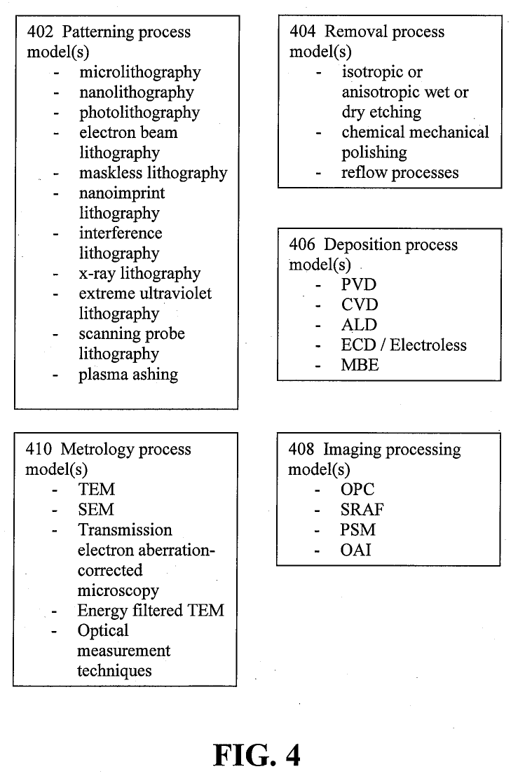

FIG. 4 illustrates some examples of the concurrent models for the fabrication, metrology, or image processing processes or techniques. 402 lists some examples of the patterning process models such as but shall not be limited to microlithography, nanolithography, photolithography, electron beam lithography, maskless lithography, nanoimprint lithography, interference lithography, x-ray lithography, extreme ultraviolet lithography, scanning probe lithography, or plasma ashing. 404 lists some examples of the removal process models such as but shall not be limited to isotropic or anisotropic wet or dry etching, chemical mechanical polishing, or reflow process models. 406 lists some examples of the deposition process models such as but shall not be limited to physical vapor deposition (PVD), chemical vapor deposition (CVD), atomic layer deposition (ALD), electro-plating or electrochemical deposition (ECD), electroless deposition or auto-catalytic plating or deposition, or molecular beam epitaxy (MBE). 408 lists some examples of the image processing process models, such as but shall not be limited to, optical proximity correction (OPC), Subresolution Assist Features (SRAF), phase shifting mask (PSM), and off-axis illumination (OAI). 410 lists some examples of the pattern process models such as but shall not be limited to transmission electron microscopy (TEM), scanning electron microscopy (SEM), transmission electron aberration-corrected microscopy, energy filtered TEM, optical measurement techniques.

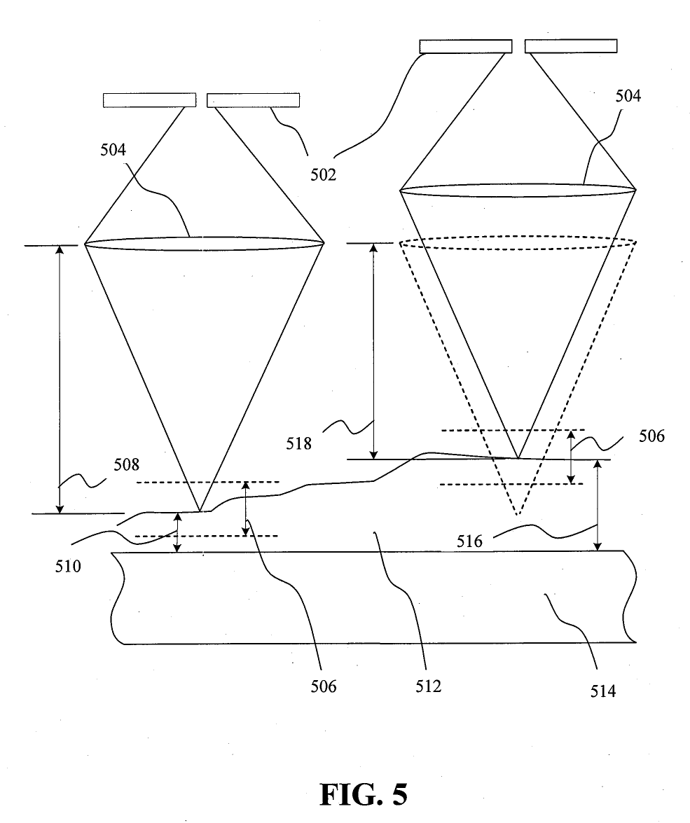

FIG. 5 illustrates an example of an impact of thickness variation of the film on the lithography process. A simplified lithographic apparatus with a depth of focus, 506, comprises the mask, 502, and a reduction lens, 504, is positioned at a first location at a distance of d₁, 508, above the film 512 on the wafer 514 where the film thickness is t₁, 510.

When the same lithographic process is to be applied to a second location where the film thickness is t₂, 516, at least two problems may arise to cause feature dimension variation or even yield loss. The first problem is whether the film thickness variation, t₂−t₁ is within the depth of focus (DOF), 506, of the lithographic process at a given wavelength. If the film thickness variation is beyond the DOF, the film may not obtain sufficient exposure and/or contrast, and the lithographic process may fail and cause yield loss. One embodiment of the invention adjusts the position of the lithographic apparatus and the mask to accommodate the topographical variation from die to die as show in the right hand portion of FIG. 5. However, for thickness variations within die, it may be impossible to adjust the stepper. However, normal semiconductor processing tools are not likely to produce such a large thickness variation within a single process step, especially in light of the fact that the depth of focus is nearly 2λ for a numerical aperture (NA) of 0.7. That is, where the numerical aperture is 0.7, the thickness must vary more than 0.4 μm to be outside the depth of focus for a 193 nm lithography tool. This is, however, an unlikely result for a modern process tool. Nonetheless, any shift of focus causes a loss of exposure latitude, potentially affecting yield. Therefore, another embodiment takes the process models and the within-die thickness variation information and modifies the design to prevent such a large thickness variations from occurring or at least reduce the within-die thickness variations.

Even if the thickness variation is within the DOF of the lithographic process, the reduction lens, 504, is now located at a distance of d₂, 518, which is shorter than d₁, 508, by the thickness differential, t₂−t₁. As a result, a different area on the film at the second location will be exposed to the light at a different intensity unless the position of the lithographic process and the mask are adjusted to compensate the topographical variation. Another embodiment of the invention, without moving the lithographic apparatus and the mask, takes the lithographic model together with the topographical variation into consideration, analyzes the impact of the lithographic process and topographical variation, and determines their impact on the feature dimensions as well as electrical or dielectric properties of the features.

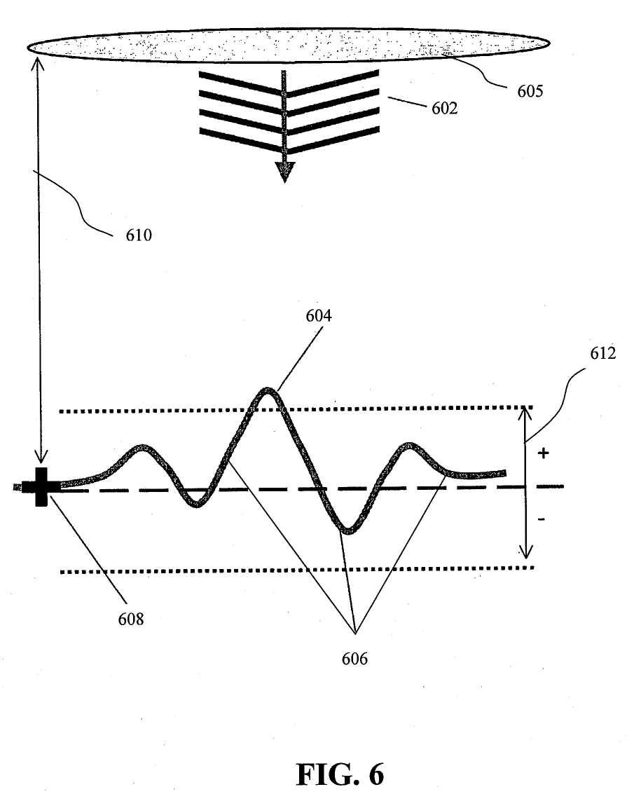

FIG. 6 illustrates a more detailed example of the impact of topographical variation on the DOF of the lithographic process. The deposition or planarization process caused within-die variations, 606 and 606. The stepper of a lithographic system having a depth of focus, 612, adjusts the system so that the focal length, 610, matches an alignment mark, 608. The energy, 602, then passes through the reduction lens, 605, and prints the circuit. If the variation exceeds the DOF at 604, the printed circuit at 604 may not accurately represent the critical dimensions of the design, and the errors may negatively impact the performance of the device or even cause yield loss.

On the other hand, if the variation stays within the DOF as in locations 606, the printed circuit in these locations may get a different intensity of exposing energy and may exhibit different dimensions from the intended dimensions. Even though these deviations from the intended design dimensions may not cause as severe of a problem with the yield, such variations may negatively impact other design objectives such as the electrical performances and timing goals. One embodiment then takes and analyzes the one or more concurrent models for the fabrication, metrology, or image processing processes or techniques and make corresponding yet more realistic adjustments to the design to more efficiently and effectively achieve the design objectives as opposed to the traditional methods of sizing the gates with different drive strengths or manipulating the wire widths. Such adjustments may comprise, but are not limited to, adding or subtracting film thickness in certain areas, adding dummy fills, or adding redundant vias. Another embodiment predicts the variations of the feature dimensions based upon the analysis of the one or more concurrent models for the fabrication, metrology, or image processing processes or techniques and provides such predictions to the designer who can thus avoid such problems during the design stage.

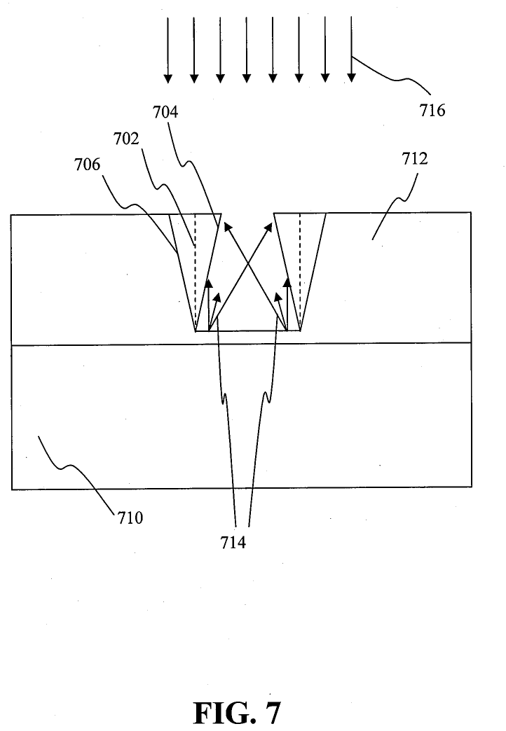

FIG. 7 illustrates an example of the impact of a concurrent model on a feature profile and dimensions. In FIG. 7, the film, 712, on top of a wafer, 710, is subject to, for example, a fabrication process, 716. Such integrated circuit fabrication processes or techniques may comprise, for example but not limited to, deposition processes such as physical vapor deposition (PVD), chemical vapor deposition (CVD), atomic layer deposition (ALD), electrochemical deposition or electro-plating (ECD), electroless deposition or auto-catalytic plating or deposition, and molecular beam epitaxy (MBE), removal processes such as isotropic or anisotropic wet or dry etching, chemical mechanical polishing (CMP), or reflow processes, patterning processes such as lithography, modification of properties such as ion implantation, annealing, oxidation, UVP (ultraviolet light processing). More specifically, lithography processes or techniques comprise microlithography, nanolithography, photolithography, electron beam lithography, maskless lithography, nanoimprint lithography, interference lithography, x-ray lithography, extreme ultraviolet lithography, or scanning probe lithography, or the plasma ashing processes.

In some embodiments of the present invention where the fabrication process is a deposition process, the designer may intend to create a desired profile of a feature as shown by the dotted lines at 702. However, redeposition or resputtering, 714, may occur from the bottom or side walls of the electronic circuit design feature and actually cause the width of the feature to shrink to a first trapezoidal profile, 704. Such a first trapezoidal profile of the feature may impact various properties of the feature of the electronic circuit in various manners due to the departure of various features from their nominal or intended profiles and the resulting changes in the physical, chemical, and/or electrical properties. For example, a change in the cross-sectional profile of a feature may change the electrical resistance and capacitance of a conductor and thus may change the timing characteristics of the electronic circuit.

Some embodiments of the present invention may determine the approximate profiles of the wires or other electronic design features based upon the input information of the process conditions or parameters. The process conditions or parameters may comprise specific information of the processing equipment or processing recipe such as, but not limited to, the bias potential, plasma densities and distribution, vacuum level of the processing chamber, power supplied to sustain the plasma, wafer pedestal temperature distribution and control, other information such as the design layout, or information about the manufacturing-specific variations of fabrication processes. Some other embodiments capture some or all of the input information by directly simulating the processes or techniques. Some other embodiments capture some or all of the input information by measuring the results on a test patterned wafer against certain metrics. Some other embodiments obtain the wire profiles by integrating, for each point along the cross-section of each of the wire profiles, a probability distribution function for the sputtering of materials, e.g., a cosine distribution function for any sputtering point source, along the entire path of the profile and then analyze or calculate the accumulation of the sputtered materials at other points along the same cross-section of the wire profile. Some other embodiments analyze and calculate the approximate feature profiles by simulating the fabrication processes (such as isotropic or anisotropic etching processes) together with the information of the electronic circuit design and the fabrication processes.

In some other embodiments where the fabrication process, 716, constitutes an etching process such as an anisotropic or an isotropic etching process, the upper portion of the side walls is subject to different characteristics of the process such as different bias potential or a different plasma density and thus may exhibit a faster etch rate to form a second trapezoidal profile, 706. Thus, etch may have different widths at the top and bottom of the etched feature due to sidewall angle and have different etched depths that depend upon interaction between specific layout pattern geometries, for example aspect ratio of a feature or density of a group of features, and the etch process. Such a trapezoidal profile of the feature may also impact various properties of the feature of the electronic circuit in various manners due to the departure of various features from their nominal or intended profiles and the resulting changes in the physical, chemical, and/or electrical properties.

Some other embodiments further analyze the impact of these process, metrology, or image processing models on the film, 712. Some other embodiments take these analysis results and forward them onto the next fabrication level. The method or the system of some embodiments of the present invention on the next fabrication or interconnect level incorporates these profiles and/or variations in feature dimensions or profiles of the features on a underlying level or level to determine the corresponding variations in electrical properties or in the profiles or dimensions of features of the electronic circuit on the next layer or level. Such electrical properties may include but are not limited to bulk resistivity, bulk resistance, wire capacitance, power consumption and may be further incorporated in the method or the system of various embodiments of the invention to determine whether some of the nets constitute critical nets and whether the design meets the design objectives such as the timing goals in some other embodiments.

Some embodiments translate the information about the process models and/or the design elements into a separate set of requirements without unnecessarily disclosing such one or more models for the fabrication, metrology, lithography, and/or image processing and/or the design elements to third parties. These methods are particularly useful in protecting the ownership of intellectual property and rights therein. For example, the semiconductor Fabs may not wish to disclose such information to IC design houses; the processing equipment manufacturers may not wish to disclose the true capabilities of their processing equipment to other parties; and IP core owners may wish to grant only the right to use without disclosing the details of such IP cores to the licensees or users.

Some other embodiments further obtain the information about the fabricated features of the design and use such information to further calibrate the process models as well as the modifications to the design itself or the fabrication processes so as to improve the accuracy and effectiveness of the methods or systems described above.

Some other embodiments may use hierarchical models that trade-off computational speed and prediction accuracy. An application of this may involve using faster, less accurate models to examine large portions of a given design and slower more accurate models in smaller regions that become a concern.

Some other embodiments further utilize systems utilizing parallel computing architecture to achieve the purpose. Some other embodiments also store the three-dimensional wire/feature profile in a data structure or a database for subsequent retrieval as well as use.

Some other embodiments may be applied where only a portion of the final complete layout, for example one or more blocks or cells, is available. A context simulation method may be used to introduce likely geometric environments into the incomplete regions, for example structures with similar densities or line widths, or an environment with a geometric distribution based on prior designs. For processes with large pattern interaction ranges such as CMP, simulation of layout portions not available may be useful. More details about context simulation is described in U.S. patent application Ser. No. 11/768,851, entitled “METHOD AND SYSTEM FOR IMPLEMENTING CONTEXT SIMULATION” filed on Jun. 26, 2007 under Attorney Docket No. CA7051752001, which is incorporated herein by reference in its entirety.

### System Architecture Overview

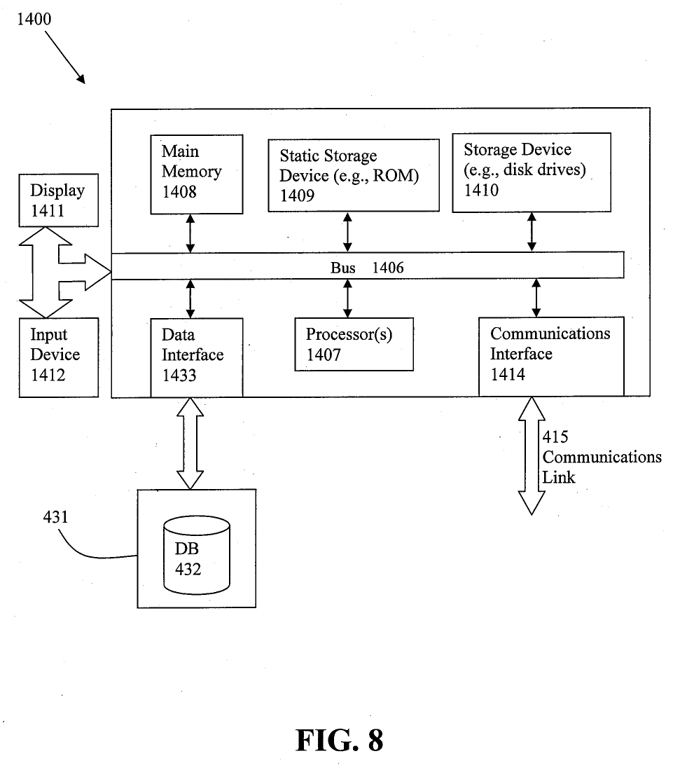

FIG. 8 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control (not shown).

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media, volatile media, and transmission media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution. Computer system 1400 may also interact with a database system 1432 via a data interface 1433 where the computer system 1400 may store and retrieve information or data of the electronic design into and from the database system.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A machine-implemented method for predicting performance, manufacturability, or reliability (PMR) with concurrent model analysis, comprising:
identifying an electronic circuit design for an electronic circuit to be manufactured by a first manufacturing process;
identifying a first concurrent model of the first manufacturing process for a first level of the electronic circuit;
determining a first geometric characteristic of a first feature of the first level based upon the first concurrent model;
determining a first metric of the first level based upon the first geometric characteristic of the first feature of the first level;
determining whether a first PMR requirement is satisfied for the electronic circuit based upon the first geometric characteristic or the first metric; and
displaying the first geometric characteristic of the first level or storing the first geometric characteristic in a tangible computer accessible medium.

2. The machine-implemented method of claim 1, in which the first manufacturing process comprises a fabrication process or technique, a metrology process or technique, or an image processing process or technique.

3. The machine-implemented method of claim 1, in which the first geometric characteristic comprises a dimension or a profile of the first feature.

4. The machine-implemented method of claim 1, further comprising:
determining whether there is a second level of the electronic circuit.

5. The machine-implemented method of claim 4, in which the second level of the electronic circuit is determined to exist, further comprising:
forwarding the first geometric characteristic or the first metric to the second level for analysis.

6. The machine-implemented method of claim 4, in which the second level of the electronic circuit is determined to exist, further comprising:
identifying a second concurrent model of a second manufacturing process for the second level of the electronic circuit;
determining a second geometric characteristic of a second feature of the second level based upon the second concurrent model; and
determining a second metric of the second level based upon the second geometric characteristic of the second feature.

7. The machine-implemented method of claim 6, further comprising:
determining whether a second PMR requirement is satisfied for the second level based upon the second characteristic or the second metric.

8. The machine-implemented method of claim 6, further comprising:
determining whether a third PMR requirement is satisfied for the electronic circuit based upon the first geometric characteristic, the first metric, the second geometric characteristic, or the second metric.

9. The machine-implemented method of claim 4, further comprising:
determining whether a third PMR requirement is satisfied for the first and the second level combined.

10. The machine-implemented method of claim 1, in which the first metric comprises an electrical, physical, chemical, or thermal characteristic related to the first level of the electronic circuit.

11. The machine-implemented method of claim 5, in which the electrical characteristic comprises electrical resistivity, capacitance, inductance, or a derivative electrical characteristic of a feature on the first level of the electronic circuit.

12. The machine-implemented method of claim 6, in which the derivative electrical characteristic is determined based upon one or more of the electrical resistivity or capacitance and may comprise electrical resistance, current density, IR drop, power consumption, RC time constant, or capacitive load of the feature on the first level of the electronic circuit.

13. The machine-implemented method of claim 5, in which the physical characteristic related to the first level of the electronic circuit comprises uniformity of a feature across the first level of the electronic circuit design, uniformity of the feature from a first die to a second die, or uniformity of the feature from a first wafer to a second wafer.

14. The machine-implemented method of claim 5, in which the chemical characteristic related to the first level of the electronic circuit comprises a composition, bulk density, or distribution of a feature on the first level of the electronic circuit.

15. The machine-implemented method of claim 1, in which the first or the second PMR requirement comprises a performance requirement, a manufacturability requirement, or a reliability requirement.

16. The machine-implemented method of claim 1, in which the performance requirement comprises a timing requirement or a power consumption requirement.

17. The machine-implemented method of claim 8, in which the first concurrent model is substantially similar to the second concurrent model.

18. The machine-implemented method of claim 7, in which the first manufacturing process is substantially similar to the second manufacturing process.

19. The machine-implemented method of claim 7, comprising:
calibrating the first concurrent model or the second concurrent model with information obtained from a patterned test wafer or from a source with limited fidelity.

20. The machine-implemented method of claim 7, in which the identifying a first concurrent model or the identifying a second concurrent model comprises directly modeling underlying physics of the manufacturing process, modeling underlying physics in conjunction with the information obtained from a patterned test wafer or a source of limited fidelity, or constructing rules based upon the information obtained from a patterned test wafer or a source of limited fidelity.

21. The machine-implemented method of claim 1, further comprising:
combining the concurrent model with additional measured or model produced statistical variability to produce a distribution of values related to the first geometric characteristic.

22. The machine-implemented method of claim 1, in which a portion of the layout is generated by a context simulation method.

23. A system for predicting performance, manufacturability, or reliability (PMR) with concurrent model analysis, comprising:
means for identifying an electronic circuit design for an electronic circuit to be manufactured by a first manufacturing process;
means for identifying a first concurrent model of the first manufacturing process for a first level of the electronic circuit;
means for determining a first geometric characteristic of a first feature of the first level based upon the first concurrent model;
means for determining a first metric of the first level based upon the first geometric characteristic of the first feature of the first level;
means for determining whether a first PMR requirement is satisfied for the electronic circuit based upon the first geometric characteristic or the first metric; and
means for displaying the first geometric characteristic of the first level or storing the first geometric characteristic in a tangible computer accessible medium.

24. A computer program product comprising a computer-usable storage medium having executable code to execute a process for predicting performance, manufacturability, or reliability (PMR) with concurrent model analysis, comprising:
identifying an electronic circuit design for an electronic circuit to be manufactured by a first manufacturing process;
identifying a first concurrent model of the first manufacturing process for a first level of the electronic circuit;
determining a first geometric characteristic of a first feature of the first level based upon the first concurrent model;
determining a first metric of the first level based upon the first geometric characteristic of the first feature of the first level;
determining whether a first PMR requirement is satisfied for the electronic circuit based upon the first geometric characteristic or the first metric; and
displaying the first geometric characteristic of the first level or storing the first geometric characteristic in a tangible computer accessible medium.
